(19) United States
(12) Patent Application Publication
(10) Pub. No.: US 2005/0216684 A1
(43) Pub. Date: Sep. 29, 2005

(54) Information recording medium, data processing apparatus, and recording region setting method of information recording medium

(75) Inventors: Hirokazu So, Osaka (JP); Takuji Maeda, Osaka (JP); Masato Suto, Osaka (JP); Makoto Ochi, Osaka (JP); Kazuya Fujimura, Nara (JP); Shinji Inoue, Osaka (JP); Yukiko Inoue, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/992,097

(22) Filed: Nov. 19, 2004

(30) Foreign Application Priority Data
Nov. 21, 2003 (JP) 2003-392218

(51) Int. Cl. G06F 12/00

(52) U.S. Cl. 711/163; 711/112; 711/156

(57) ABSTRACT

An information recording medium includes a data storage section having a plurality of recording regions for storing data, and a region information storing section operable to store information about each recording region in the data storage section. The region information storing section stores information about a recording region (for example, a recording region has been accessed finally) which is set first as an accessible region when the information recording medium is initialized at the next time among a plurality of recording regions in the data storage section. A data processing apparatus refers to the information about the recording region and changes over a recording region to the recording region specified by the information about the recording region just after initialization of the recording medium.

### BACKGROUND ART

1. Technical Field

The present invention relates to an information recording medium having a plurality of recording regions, a data processing apparatus for accessing data stored in the information recording medium, and a setting method of each recording region in the information recording medium.

2. Related Art

Information recording medium for recording digital data (hereinafter called “data”) such as audio contents, video contents and still picture contents has various types including semiconductor recording medium, magnetic disk, optical disk, and magneto-optical disk. In particular, the semiconductor recording medium is smaller in size and lighter in weight, and thus it is rapidly spreading widely among portable apparatuses such as digital still camera and portable telephone terminal. Representative examples of semiconductor recording medium include SD memory card (registered trademark), memory stick (registered trademark), and Compact. Flash (registered trademark).

Data stored in recording regions in these recording media are managed by a file system. In the file system, the recording regions are divided into smallest access units of sectors, and clusters composed of plural sectors, and one or more clusters are managed as a file.

An example of the conventional file system is known as FAT (File Allocation Table) file system (for detail, see non-patent document 1). The FAT file system is generally used in personal computers and other information apparatuses, and it is a major file system in semiconductor recording medium. The recording medium managed by the file system can be shared among apparatuses interpreting the same file system, and therefore data can be exchanged among a plurality of apparatuses.

The management capacity of FAT file system is 2 GB, and in semiconductor recording medium increasing in capacity year after year, it is necessary to use a new file system applicable to a larger capacity than the FAT file system. AS a file system of larger capacity, there is FAT32 system and UDF (Universal Disk Format).

However, when a file system of the recording medium is changed to one with larger capacity, the apparatus used in the conventional FAT file system cannot access data in the recording medium.

To solve this problem, it has been proposed to set a region for storing management information of a plurality of file systems, and a region for storing common file data in a recording medium (see, for example, Patent document 1).

Patent document 1: JP,08-272541,A

Non-patent document: ISO/IEC9293, “Information Technology-Volume and file structure of disk cartridges for information”, 1994.

In the conventional control method, however, when updating one file data, management information of a plurality of file systems must be updated at the same time. Thus in the apparatus applicable to one file system only, management information of the other file systems which the apparatus can not handle can not be updated and hence file data cannot be updated. It is hence proposed to set a plurality of recording regions in the recording medium, and manage data by an independent file system in each recording region. According to this method, even in the apparatus applicable to one file system only, the file data can be updated in the recording region of which data is managed by the applicable file system.

When the recording medium has a plurality of recording regions, it is required to determine one region of the recording medium to be accessed by the data processing apparatus.

For example, as region determining method, the following manner can be considered. That is, just after initialization of the recording medium, only the recording region (hereinafter called “recording region A”) having been managed by the file system used by the conventional apparatus is accessible, and access to another recording region (hereinafter called “recording region B”) is allowed only after changing over the recording regions. In this manner, it is possible to provide the recording medium capable of being shared between the conventional apparatus and a new apparatus. That is, the conventional apparatus accesses recording region A only, while the new apparatus can access both recording region A and recording region B.

In this case, however, always just after initialization, only region A is accessible, and the following problem occurs.

Suppose the user writes data in recording region B of a recording medium by using apparatus X, and inserts this recording medium in other apparatus Y. It is noted that the apparatus Y is accessible to both recording region A and recording region B. In the region determining method mentioned above, just after the recording medium is inserted in apparatus Y, recording region A is accessible. In apparatus Y, hence, the data written in recording region B cannot be read, and the user may misunderstand as that the written data is missing, and may be confused.

Even if the user recognizes and understands that the recording medium has at least two recording regions including recording regions A and B, and that only recording region A is accessible at the beginning, after inserting the recording medium in apparatus Y, it is necessary to instruct to change over a recording region from recording region A to recording region B, and it is not easy to use.

It is hence an important problem to determine where the region accessible first by the data processing apparatus is set when the recording medium having a plurality of recording regions is loaded into the data processing apparatus.

### SUMMARY OF THE INVENTION

In the light of the above problems, it is an object of the invention to present a recording medium, a data processing apparatus, and a setting method of recording regions in the recording medium, capable of automatically setting a region first accessible by a data processing apparatus to an appropriate region, when a recording medium having a plurality of recording regions is loaded into the data processing apparatus.

An information recording medium according to the present invention is a recording medium to or from which data can be written or read by a data processing apparatus. The recording medium includes a host interface operable to communicate with the data processing apparatus, a data storage section having a plurality of recording regions for storing data, and a region information storing section operable to store information about each recording region in the data storage section. The region information storing section stores information about a recording region which is set first as an accessible region when the information recording medium is initialized at the next time among a plurality of recording regions in the data storage section.

The information about a recording region which is set first as an accessible region may be information about a recording region which has been accessed finally by the data processing apparatus in a plurality of recording regions.

The information about a recording region which is set first as an accessible region may be information about a recording region which is specified by the data processing apparatus as a region to be validated after the next initialization process.

The information about a recording region which is set first as an accessible region may be information about number of access in each recording region. The information about the number of access may be counted up only at the first access time after a changeover process of the recording regions. The information about the number of access may be counted up when a predetermined number of access occur after a changeover process of the recording regions. The information about the number of access may be cleared when a predetermined number of initialization processes occur.

The information about a recording region which is set first as an accessible region may be information about a recording region which is set finally as an accessible region by the data processing apparatus.

The host interface may notify the data processing apparatus of the information about a recording region which is set first as an accessible region when requested from the data processing apparatus.

A first data processing apparatus according to the present invention is a data processing apparatus for reading and writing data from and to the information recording medium described above. The first apparatus includes a medium slot operable to load the information recording medium, an I/O processor operable to exchange information with the information recording medium loaded in the medium slot, and a data processor operable to process data read from the information recording medium or data to be written to the information recording medium. The I/O processor reads the information about a recording region which is set first as an accessible region from the region information storing section of the information recording medium, and changes over the recording region in the data storage section based on the read information.

A second data processing apparatus according to the present invention is a data processing apparatus for reading and writing data from and to an information recording medium having specific identification information and including a plurality of recording regions. The second apparatus includes a medium slot operable to load the information recording medium, an I/O processor operable to exchange information with the information recording medium loaded in the medium slot, and a data processor operable to process data read from the information recording medium or data to be written to the information recording medium. The apparatus stores identification information of the information recording medium, and information about a recording region which is set first as an accessible region when the information recording medium is initialized at the next time among a plurality of recording regions in the data storage section. The I/O processor changes over the recording region in the information recording medium specified by the stored identification information, based on the identification information of the recording medium and the information about a recording region which is set first as an accessible region.

A first region setting method according to the present invention is a method of setting an accessible rerecording region in an information recording medium according described above. The first method includes reading the information about a recording region which is set first as an accessible region from the region information storing section of the information recording medium, and changing over the recording region in the data storage section based on the read information.

A second region setting method according to the present invention is a method of setting an accessible rerecording region in an information recording medium having specific identification information and including a plurality of recording regions. The second method includes storing identification information of the information recording medium, and information about a recording region which is set first as an accessible region when the information recording medium is initialized at the next time among a plurality of recording regions in the data storage section, and upon initialization of the information recording medium, changing over the recording region in the information recording medium specified by the stored identification information, based on the identification information of the recording medium and the information about a recording region which is set first as an accessible region.

According to the invention, the information of the finally accessed recording region or the information of the region specified by the data processing apparatus is stored in the information recording medium or the data processing apparatus, thereby allowing the recording region to be changed over automatically to the finally accessed recording region or a desired region specified by the data processing apparatus. Hence, for the recording medium having a plurality of recording regions, user's confusion may be lessened and user's convenience may be improved.

### BRIEF DESCRIPTION OF THE DRAWINGS

FIG. 1 is a block diagram of a recording medium and a data processing apparatus in Embodiment 1 of the present invention.

FIG. 2 shows an example of a region information storing section in Embodiment 1.

FIG. 3 is a flowchart of an example of initialization process in Embodiment 1.

FIG. 4 is a flowchart of an example of recording region changeover process in Embodiment 1.

FIG. 5 shows an example of a region information storing section after recording region changeover process in Embodiment 1.

FIG. 6 is a flowchart of an example of data reading process in Embodiment 1.

FIG. 7 shows an example of the region information storing section after data reading process in Embodiment 1.

FIG. 8 is a flowchart of an example of final access region information acquiring process in Embodiment 1.

FIG. 9 is a flowchart of an example of preparation process in Embodiment 1.

FIG. 10A shows an example of the region information storing section in modified example of Embodiment 1.

FIG. 10B shows another example of the region information storing section in modified example of Embodiment 1.

FIG. 10C shows still another example of the region information storing section in a modified example of Embodiment 1.

FIG. 11 is a flowchart of example of setting process of recording region to be validated next time in a modified example of Embodiment 1.

FIG. 12 is a block diagram of an example of a recording medium and a data processing apparatus in Embodiment 2.

FIG. 13A shows an example of the region information storing section in Embodiment 2.

FIG. 13B shows an example of final access region information in Embodiment 2.

FIG. 14 is a flowchart of an example of reading process of medium specific ID in Embodiment 2.

FIG. 15 is a flowchart of an example of data reading process on the recording medium side in Embodiment 2.

FIG. 16 is a flowchart of an example of data reading process on the data processing apparatus side in Embodiment 2.

FIG. 17 is a flowchart of an example of preparation process in Embodiment 2.

FIG. 18 is a block diagram of the recording medium and the data processing apparatus in Embodiment 3.

FIG. 19 shows an example of region information storing section in Embodiment 3.

FIG. 20 is a flowchart of an example of initialization process in Embodiment 3.

FIG. 21 is a flowchart of an example of next time validation process in Embodiment 3.

FIG. 22 is a flowchart of an example of preparation process in Embodiment 3.

### DETAIED DESCRIPTION OF THE PREFERRED EMBODIMENTS

Referring now to the accompanying drawings, preferred embodiments of information recording medium and data processing apparatus of the invention are specifically described below.

### Embodiment 1

<System Configuration>

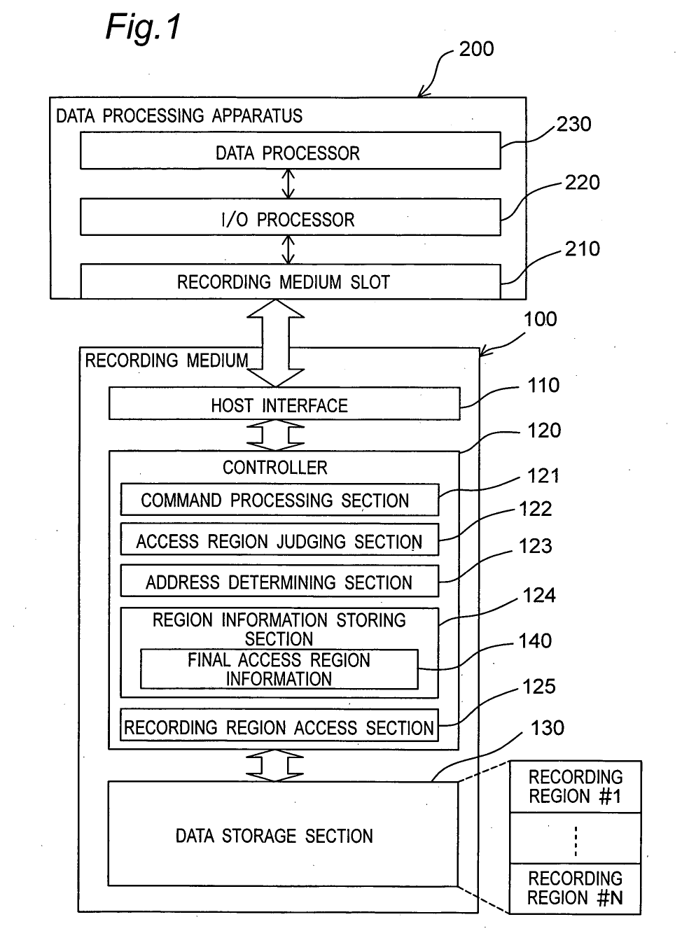

FIG. 1 is a block diagram of an information recording medium 100 and a data processing apparatus 200 in Embodiment 1 of the invention.

The recording medium 100 includes a host interface 110, a controller 120, and a data storage section 130.

The host interface 110 exchanges information with the data processing apparatus 200 which is a host machine of the recording medium 100.

The data storage section 130 has regions for storing data, and reading and writing arbitrary data from the data processing apparatus 200. The data storage section 130 is composed of N (N being a natural number) recording regions (recording region #1, . . . , recording region #N), and the data in each recording region is managed as a file by an independent file system respectively.

The controller 120 controls the inside of the recording medium 100, and includes a command processing section 121, an access region judging section 122, an address determining section 123, a region information storing section 124, and a recording region access section 125.

The command processing section 121 interprets and executes a command received from the data processing apparatus 200 in the host interface 110, and sends the result, as required, to the data processing apparatus 200 by way of the host interface 110.

The access region judging section 122 determines one recording region to access from the a plurality of recording regions of the data storage section 130 on the basis of the information stored in the region information storing section 124 in response to the access request from the command processing section 121.

The address determining section 123 determines an address to access the recording region determined by the access region judging section 122.

The region information storing section 124 stores information about each recording region, such as start address of each recording region and region size in the data storage section 130. The region information storing section 124 further includes a final access region information 140 showing the recording region finally accessed in the previous access process. This final access region information 140 is used for determining the first accessible region after initialization of the recording medium 100.

The recording region access section 125 accesses the data stored in the data storage section 130 on the basis of the information determined by the access region judging section 122 and address determining section 123.

The data processing apparatus 200 includes a recording medium slot 210, an I/O (Input/Output) processor 220, and a data processor 230.

The recording medium slot 210 is a hardware for loading a recording medium 100.

The I/O processor 220 exchanges information such as command and data with the recording medium 100 loaded in the recording medium slot 210.

The data processor 230 processes data stored in the recording medium 100 or data to be newly stored, and is responsible for a main control of the data processing apparatus 200.

<Data Structure in Region Information Storing Section>

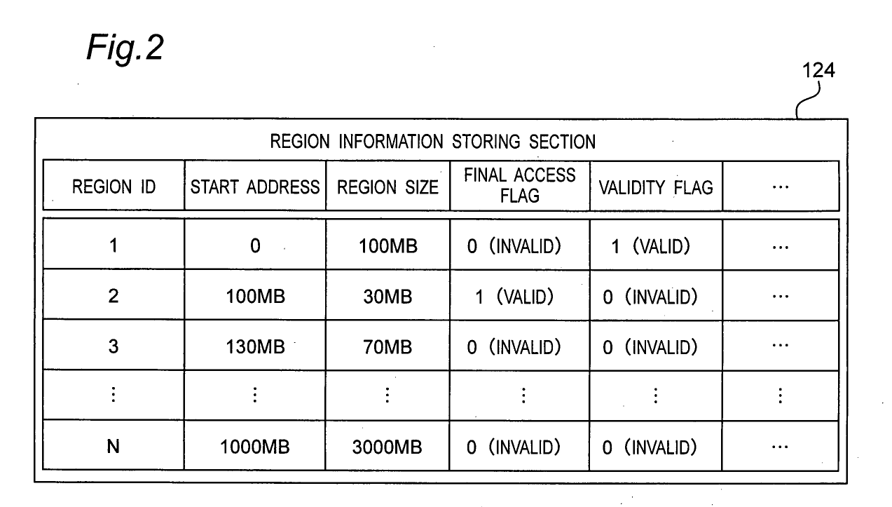

FIG. 2 shows an example of data structure in the region information storing section 124. The region information storing section 124 stores a region identification number (region ID) for identifying each recording region in the recording medium 100, a start address showing a start address of the recording region, region size showing a size of the recording region, a final access flag showing the finally accessed recording region, and a validity flag showing a recording region which is presently valid. Region information including these information as one set is provided corresponding to each recording region in the data storage section 130, being present as many as the number of recording regions. In the example in FIG. 2, the data storage section 130 is divided into N recording regions, and the first recording region (recording region #1) is a region which starts from the beginning address of the data storage section 130 and has a size of 100 MB. Similarly, the second recording region (recording region #2) is a region which starts from a position deviated by 100 MB from the beginning of the data storage section 130 and has a size of 30 MB. The third recording region (recording region #3) is a region which stars from a position deviated by 130 MB from the beginning of the data storage section 130 and has a size of 70 MB. N-th region is a region which starts from a position deviated by 1000 MB from the beginning of the data storage section 130 and has a size of 3000 MB.

Herein, the final access flag corresponds to the final access region information 140, showing which recording region has been accessed finally among the first to N-th recording regions. The example in FIG. 2 shows that the second recording region is the finally accessed recording region.

The validity flag shows which recording region can be accessed from the data processing apparatus 200 presently among the first to N-th recording regions, and the example in FIG. 2 shows that the first recording region is accessible at the present.

<Initialization Process>

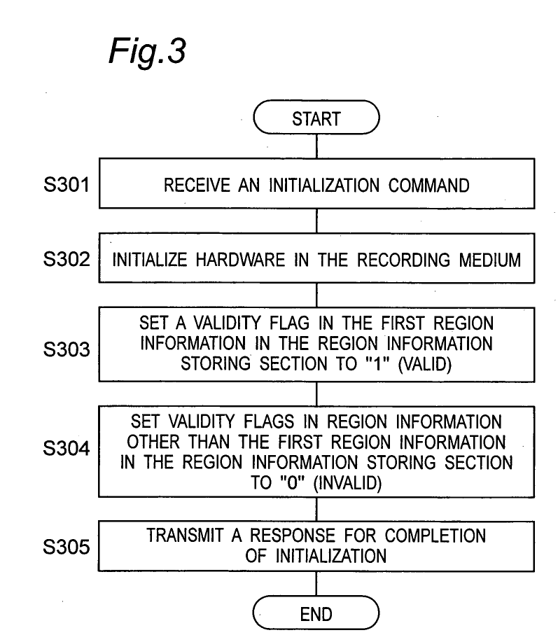

Initialization process of the recording medium 100 in this embodiment is explained. When the recording medium 100 is connected to the data processing apparatus 200, the data processing apparatus 200 transmits an initialization command to the recording medium 100 to initialize the recording medium 100. FIG. 3 is a flowchart showing a flow of initialization process in the recording medium 100.

In the initialization process, first, the host interface 110 of the recording medium 100 receives an initialization command from the data processing apparatus 200 (S301).

Then the controller 120 and data storage section 130 in the recording medium 100 are initialized, and the recording medium 100 is now accessible from outside (S302).

The validity flag of the first region information of a plurality of region information included in the region information storing section 124 is set to “1” (valid) (S303). Next, all validity flags in other region information than the first region information are set to “0” (invalid) (S304).

Finally, a response showing completion of initialization process is sent to the data processing apparatus 200 by way of the host interface 110 of the recording medium 100 (S305).

At the moment of completion of initialization process, the region information storing section 124 in the recording medium 100 is as shown in FIG. 2, that is, the validity flag is set only in the first region, and only the first recording region can be accessed from the data processing apparatus 200. In this case, preferably, the first region in the recording medium 100 may be managed by a relatively old file system such as FAT file system. In this manner, an apparatus applicable to an old file system can always access an available region by initializing the recording medium, while an apparatus applicable to a relatively new file system such as FAT32 file system can use wider recording regions by changing over the region as mentioned below.

<Recording Region Changeover Process>

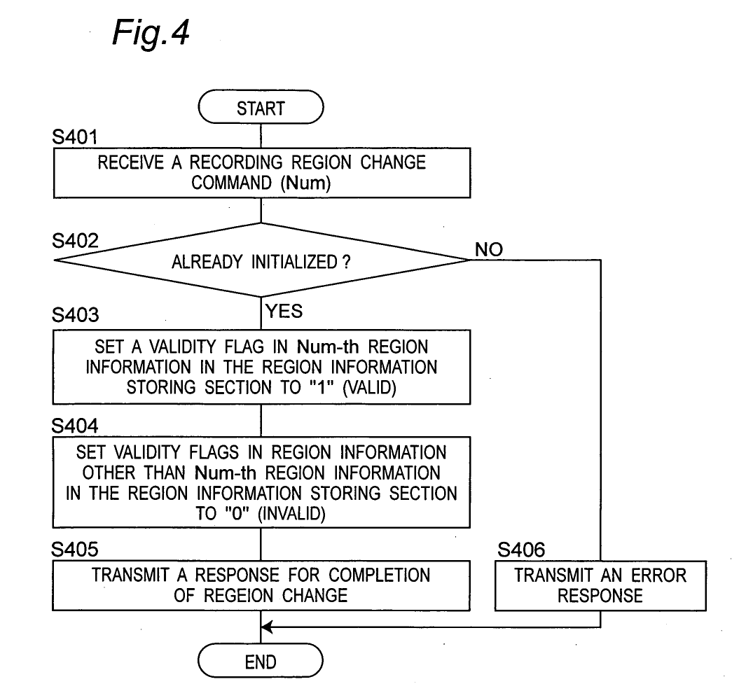

The following is the explanation about the recording region changeover (setting) process in the embodiment. The recording region changeover process is executed by sending a recording region change command from the data processing apparatus 200 to the recording medium 100 while specifying the region identification number of the recording region desired to be validated. FIG. 4 is a flowchart of recording region changeover process in the recording medium 100.

In the recording region changeover process, first, the host interface 110 of the recording medium 100 receives a recording region change command from the data processing apparatus 200 (S401). The recording region change command has the following format:
Area_Change (Num).

The argument “Num” is used for setting the region identification number, that is, specifying the region identification number of the recording region desired to be changed over.

The command processing section 121 judges if the recording medium 100 has been initialized or not (S402). If not initialized, an error response is sent to the data processing apparatus 200 by way of the host interface 110 of the recording medium 100, and the process is terminated (S406).

If already initialized, the command processing section 121 refers to the region identification number (Num) specified by the recording region change command, and sets the validity flag in the region information storing section 124 for the recording region corresponding to the region identification number (Num) to “1” (valid) (S403).

In other regions than the recording region of setting the validity flag, all validity flags are set to “0” (invalid) (S404).

Finally, a response showing completion of recording region changeover process is sent to the data processing apparatus 200 by way of the host interface 110 of the recording medium 100 (S405).

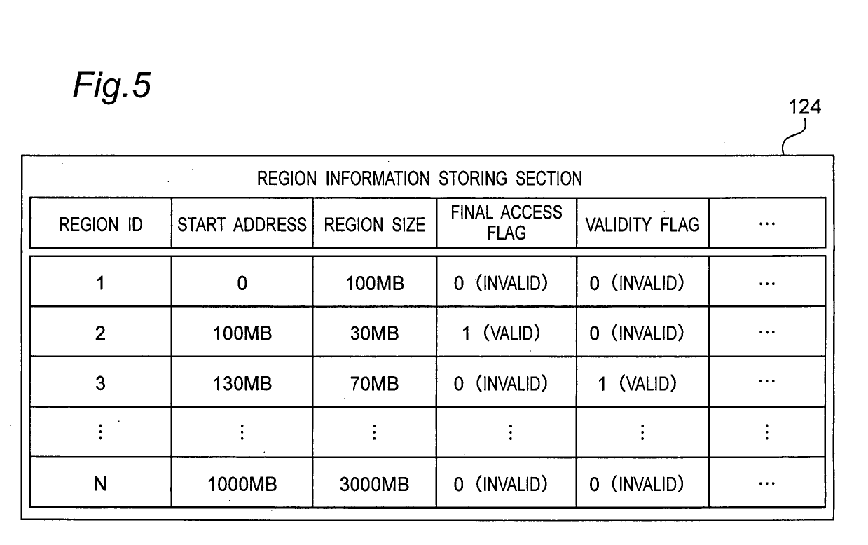

FIG. 5 shows an example of the region information storing section 124 in the recording medium 100 after the recording the region changeover process. This drawing shows an example of specifying “3” as the argument “Num” in the recording region change command. The validity flag is set valid in the third region only, and only the third region can be accessed from the data processing apparatus 200.

<Data Reading Process>

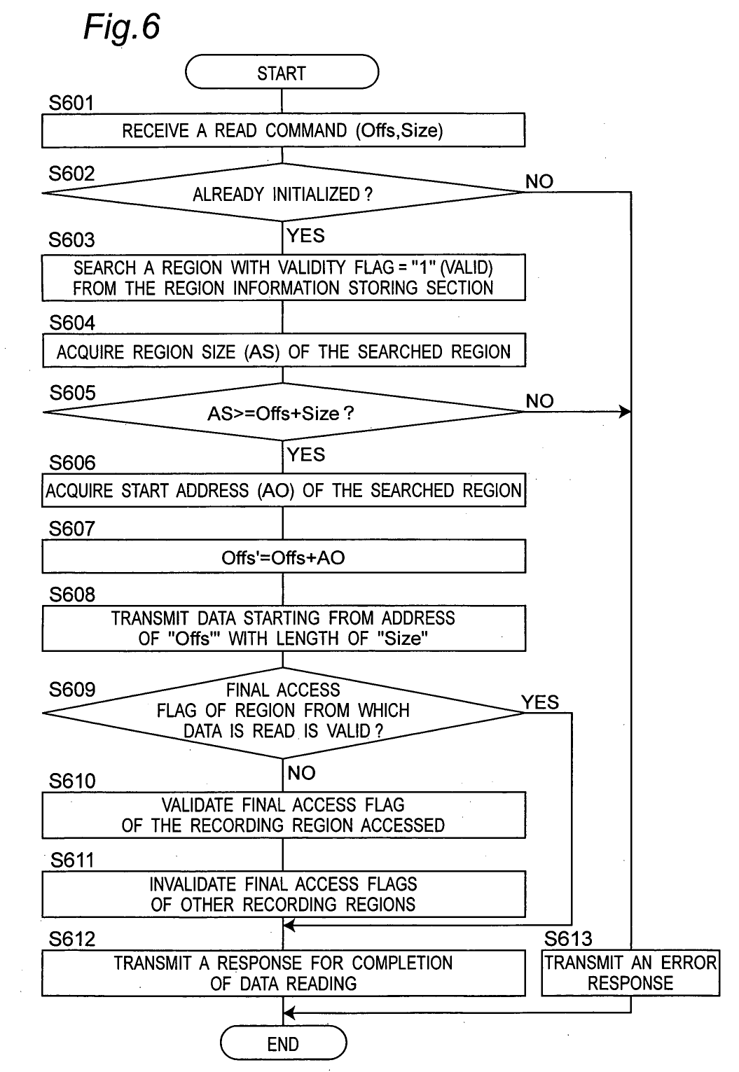

The access procedure to the recording medium 100 in this embodiment is explained by referring to an example of data reading process. Data reading or writing in the recording medium 100 is executed by sending a read or write command to the recording medium 100. FIG. 6 is a flowchart showing the data reading process in the recording medium 100.

In the data reading process, first, the host interface 110 of the recording medium 100 receives a read command from the data processing apparatus 200 (S601). The read command has the following format:
Read (Offs, Size).

The start address for reading is specified by the first argument “Offs”, and the size of data to be read is specified by the second argument “Size”.

The command processing section 121 judges if the recording medium 100 has been initialized or not (S602). If not initialized, an error response is sent to the data processing apparatus 200 by way of the host interface 110 of the recording medium 100, and the process is terminated (S613).

If already initialized, the access region judging section 122 refers to the region information storing section 124, and searches for region information of which validity flag is “1” (valid) (S603).

The address determining section 123 acquires region length AS from the region information obtained as a result of searching (S604).

Further, the address determining section 123 compares the sum of first argument Offs and second argument Size with region length AS, and checks if all reading regions are included in the accessible regions or not (S605). If AS is smaller, reading regions are wider than the accessible regions, and an error response is sent to the data processing apparatus 200 by way of the host interface 110 of the recording medium 100, and the process is terminated (S613).

If AS is larger than (Offs+Size), start address A0 is acquired from the region information as a result of search at S603 (S606).

To determine the reading start address in the recording region, Offs' which is a sum of A0 and Offs is calculated (S607).

The recording region access section 125 reads data from the start position of “Offs” with data size of “Size”, and sends the read data to the data processing apparatus 200 by way of the host interface 110 of the recording medium 100 (S608).

Further, the access region judging unit 122 sets a final access flag of the recording region from which the data has been just read out to “1” (valid). More specifically, it is judged if the final access flag is “1” (valid) or not in the recording region from which the data has been just read out (S609). If the final access flat is not “1” (valid), the final access flag is set to “1” (valid) (S610), and all final access flags in other regions than the recording region from which the data has been just read out are set to “0” (invalid) (S611).

Finally, a response showing completion of data reading process is sent to the data processing apparatus 200 by way of the host interface 110 of the recording medium 100 (S612). Thus, within the recording medium 100, the information of the recording regions valid presently is managed, and the access position specified from the data processing apparatus 200 is converted to a physical address in the presently valid recording region, so that access to a specified recording region in the a plurality of divided recording regions is enabled.

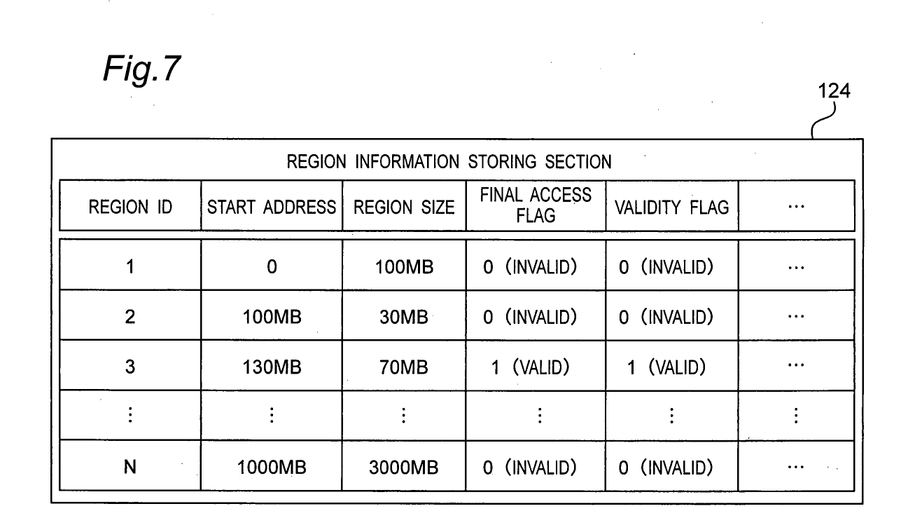

FIG. 7 shows an example of the region information storing section 124 in the recording medium 100 after the data reading process. This drawing shows an example just after reading out data from the recording region with the region identification number “3”. The final access flag is set valid only in the third region, holding a state that the recording region finally accessed by the data processing apparatus 200 is the third recording region.

In this manner, every time the access occurs, the final access flag of the region information storing section 124 is confirmed and updated as required so that the value of the final access flag may be always maintained in the latest state.

<Acquisition of Final Access Region Information>

The following is the explanation about procedure of acquiring information (final access region information 140) of recording region finally accessed in the recording medium 100 in the embodiment.

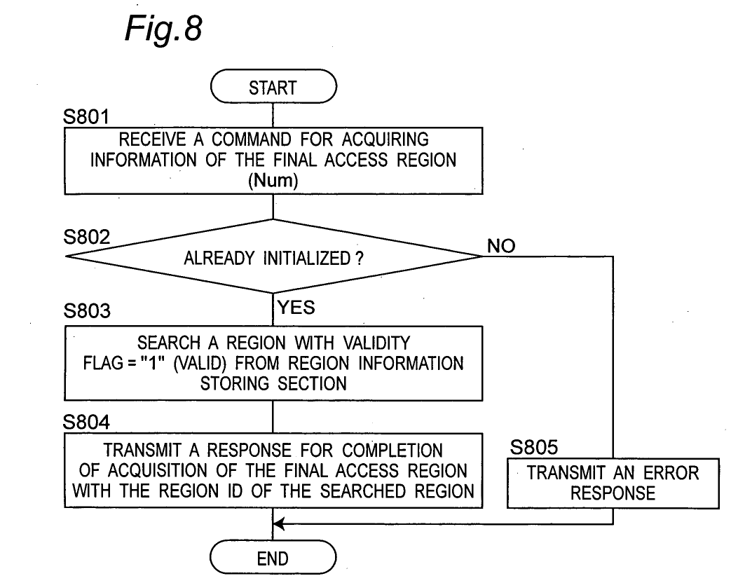

To acquire the final access region information, an acquisition command of final access region information is sent from the data processing apparatus 200 to the recording medium 100. FIG. 8 is a flowchart of process for acquiring final access region information at the side of the recording medium 100.

In the acquisition process of final access region information, first, the host interface 110 of the recording medium 100 receives an acquisition command of final access region information from the data processing apparatus 200 (S801).

The command processing section 121 judges if the recording medium 100, has been initialized or not (S802). If not initialized, an error response is sent to the data processing apparatus 200 by way of the host interface 110 of the recording medium 100, and the process is terminated (S805).

If already initialized, the access region judging section 122 searches for a region of which final access flag is “1” (valid) in the region information in the region information storing section 124 (S803).

Finally, the data processing apparatus 200 is notified of completion of acquisition process of the final access region information together with the region identification information in the region information as a result of search at S803, by way of the host interface 110 of the recording medium 100 (S804).

<Preparation Process Before Start of Access Operation>

Explained here is a preparation process which is executed by the data processing apparatus 200 in the embodiment before the access to the recording medium 100 loaded in the slot 210 is started.

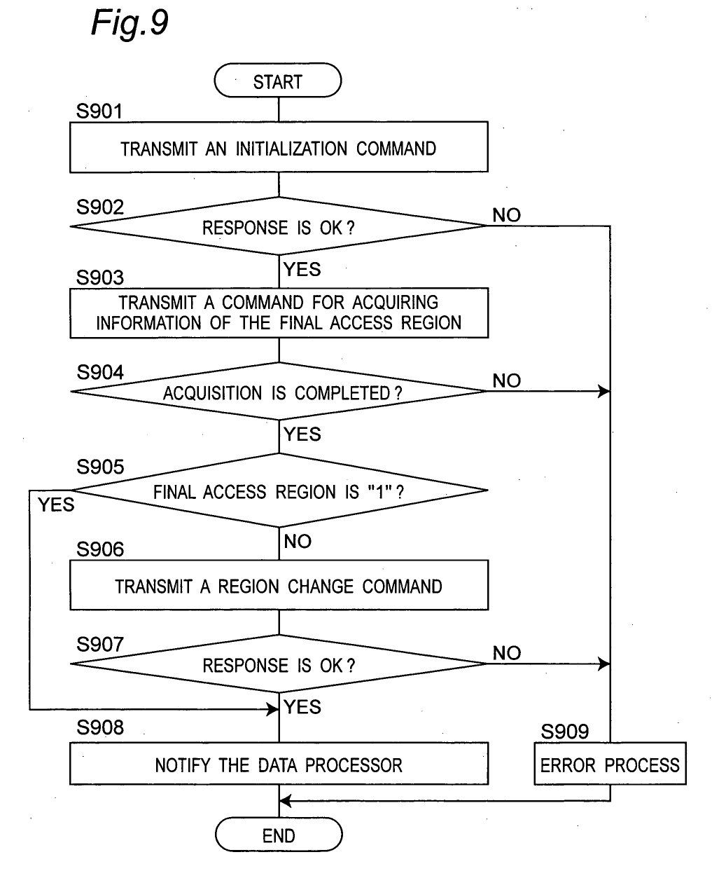

The preparation process is executed just after the recording medium 100 is loaded in the recording medium slot 210 of the data processing apparatus 200, or when the data processing apparatus 200 is powered on. FIG. 9 is a flowchart of the preparation process.

In the preparation process, first, the I/O processor 220 of the data processing apparatus 200 sends an initialization command to the recording medium 100 loaded in the slot 210 (S901). Receiving the initialization command, processing in the recording medium 100 is same as explained in FIG. 3. By this initialization process, the region of region identification number 1 is validated.

The I/O processor 220 checks if an initialization completion response corresponding to the initialization command has been received or not (S902), and if not received, error process is executed, and the process is terminated (S909).

If the initialization completion response is received, the I/O processor 220 sends an acquisition command of final access region information to the recording medium 100 (S903). Receiving the acquisition command of final access region information, processing in the recording medium 100 is same as explained in FIG. 8.

The I/O processor 220 checks if the final access region information (region identification information of the region of which final access flag is “1” (valid)) is acquired or not (S904), and if not acquired, error process is executed, and the process is terminated (S909).

If acquiring the final access region information, that is, the region identification information of the region of which final access flag is “1” (valid), the I/O processor 220 checks if the acquired region identification number is “1” or not (S905). That is, it is judged if the presently valid region is the region accessed finally in the last process.

If the acquired region identification number is “1”, the finally accessed region in the last process is presently valid, and the recording region is not changed over. The I/O processor 220 notifies the data processor 230 of completion of preparation process for commencement of access to the recording medium 100, and the process is terminated (S908).

On the other hand, if the acquired region identification number is not “1”, in order to validate the finally accessed region in the last process, the I/O processor 220 sends a recording region change command to the recording medium 100 (S906). At this time, the region identification number acquired at step S904 is specified as argument “Num”. When receiving the recording region change command, the process of the recording medium 100 is same as explained in FIG. 4.

The I/O processor 220 checks if a completion response of region changeover for the recording region change command is received or not (S907). If not received, an error process is executed, and then the process is terminated (S909).

If received, the I/O processor 220 notifies the data processing apparatus 230 of the completion of preparation process for commencement of access to the recording medium 100, and the process is terminated (S908).

Thus, according to the embodiment, the recording region can be changed over to a desired region by issuing a recording region change command before accessing the data in the recording medium 100. Therefore, when the data storage section 130 in the recording medium 100 is divided into a plurality of portions and a file system is constructed independently in each divided recording region, the data processing apparatus 200 can select and access a recording region managed by the file system that can be interpreted by the data processing apparatus 200. Since the final access region information 140 is held in the recording medium 100, by referring to this information before start of access to the recording medium 100, the data processing apparatus 200 can preliminarily change over the accessible region to the finally accessed recording region of the previous process. Hence, convenience is enhanced for the user about the recording medium having a plurality of recording regions.

### MODIFIED EXAMPLES

Several modified examples of the preferred embodiment are described below.

(1) In this embodiment, the region information storing section 124 manages five types of information as one set, that is, the region identification number, the start address, the region size, the final access flag, and the validity flag. However the format is not particularly specified as far as the position and size of each recording region, presently valid recording region, and finally accesses recording region can be distinguished. For example, the information of start address may be omitted by providing a limitation that each region is always consecutive.

(2) In the embodiment, in the explanation of data reading process, the access including an access to a region exceeding a valid region is treated as an error. However, a specification which allows data which can be read to be read can be permitted.

Also in the explanation of data reading process, the reading size (Size) is set at the beginning by the data processing apparatus 200, but it may not be set preliminarily. For example, only the reading start address (Offs) may be set in advance, the recording medium 100 may sequentially read out and transmit data to the data processing apparatus 200 continuously until the data processing apparatus 200 transmits a reading stop command.

In commands such as Area-Change and Read, information other than the argument cited in the embodiment may be given as arguments.

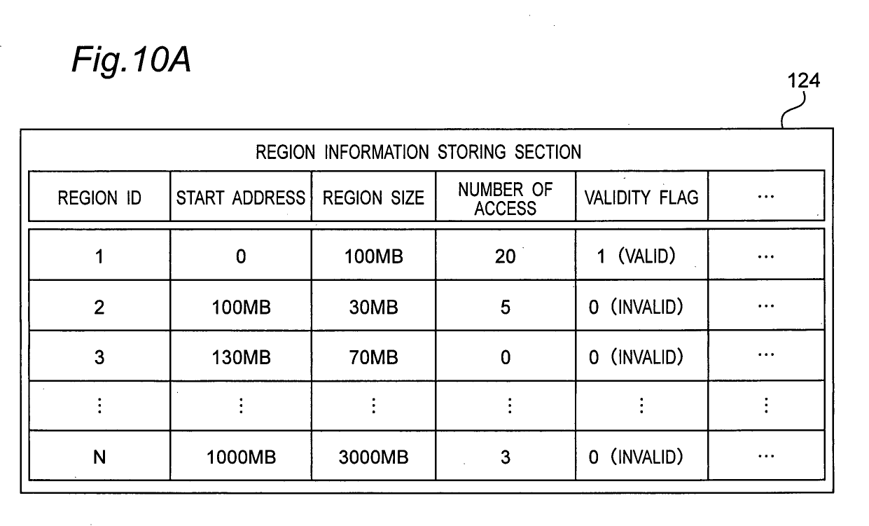

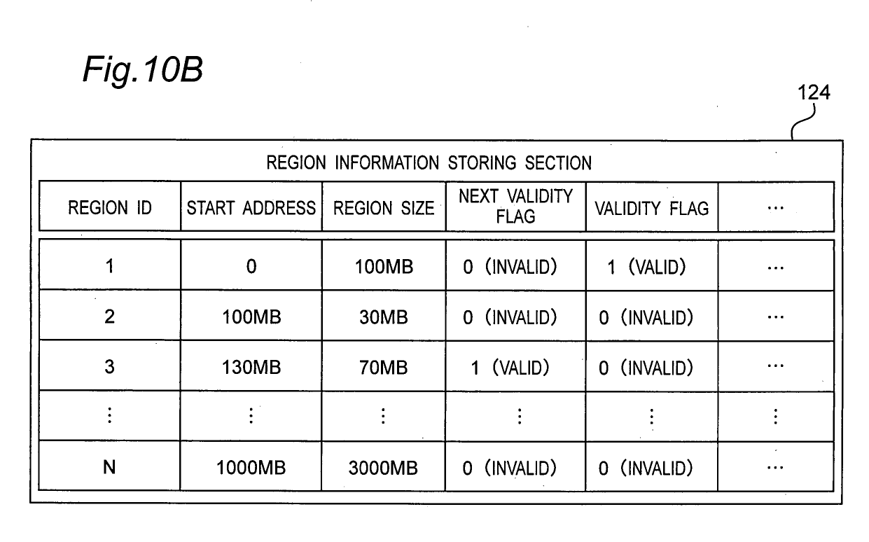

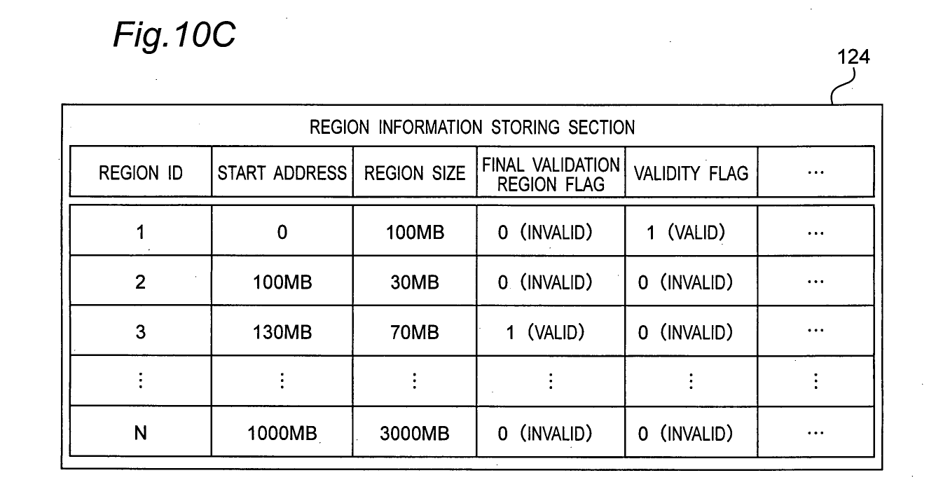

(3) In the region information storing section 124, instead of the information of the finally accessed recording region, the information of the number access in each recording region may be held. By referring to the information of the number of access, the data processing apparatus 200 can automatically change over to the recording region of the greatest number of access among a plurality of recording regions included in the recording medium 100. FIG. 10A shows an example of data composition of the region information storing section 124 in this example.

In this case, updating information of number of access every time accessing the recording region is heavy load for the recording medium 100. Therefore, instead, the information of number of access may be updated when the first access occurs after the changeover the recording region.

Alternatively, in order to suppress a bit length of the information of number of access, the information of number of access may be counted up only when a number of access is equal to or more of a predetermined number.

Further, in order to know the recording region frequently accessed recently, provided may be means for clearing the information of number of access at a specific timing. Alternatively the information of number of access may be designed to record only the fixed number of access done recently.

(4) The region information storing section 124 may hold the information of a recording region to be set as accessible region just after next initialization process.

FIG. 10B shows data composition of the region information storing section 124 in this example. The region information storing section 124 stores, instead of the final access flag, next validity flag showing the recording region to be set as accessible region after next initialization process of the recording medium 100.

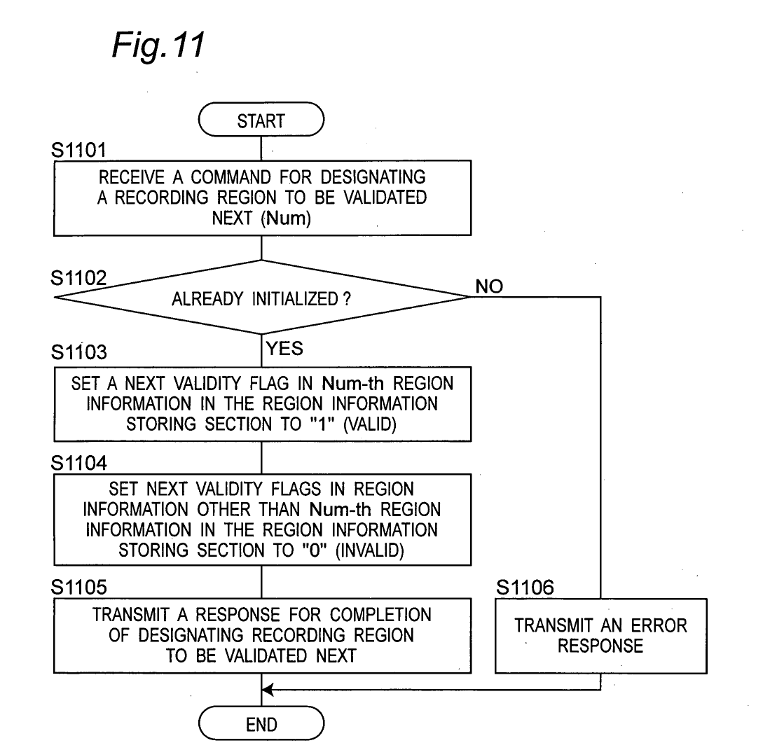

The process of specifying the recording region to be set as accessible region after next initialization process is explained. This process is executed by sending a next validation designation command by specifying the region identification number of the recording region desired to be validated after next initialization process, from the data processing apparatus 200 to the recording medium 100. FIG. 11 is a flowchart of setting process of the recording region to be validated next process in the recording medium 100.

In this setting process, the host interface 110 of the recording medium 100 receives a next validation designation command from the data processing apparatus (S1101). The next validation designation command has the following format:
Next_Area_Change (Num).

The argument “Num” specifies the region identification number of the recording region desired to be validated in the next process.

The command processing section 121 judges if the recording medium 100 has been initialized or not (S1102). If not initialized, an error response is sent to the data processing apparatus 200 by way of the host interface 110 of the recording medium 100, and the process is terminated (S1106).

If already initialized, the command processing section 121 refers to the region identification number specified by the next validation designation command, and sets the next validity flag to “1” (valid) in the corresponding recording region in the region information storing section 124 (S1103).

Consequently, all of next validity flags included in other information region than the recording region in which the next validity flag is set at S1103 are set to “0” (invalid) (S1104).

Finally, a response showing completion of setting process of recording region to be validated in the next process is sent to the data processing apparatus 200 by way of the host interface 110 of the recording medium 100 (S1105).

Thus, the data processing apparatus 200 can set the information of recording region desired to be accessed after the next initialization process in the recording medium 100.

The data processing apparatus 200 can acquire the information of the recording region to be validated in the next process in the same manner as when acquiring the final access region information mentioned above. In this case, by using the information of recording region to be validated in the next process instead of the information of final access region in the preparation process explained in FIG. 9, the data processing apparatus 200 can change over the recording region in the recording medium 100 to the recording region specified previously.

(5) Further in the region information storing section 124, instead of the information of the finally accessed recording region, the information of the recording region being finally validated may be held in the recording medium 100. For example, the “final validation region flag” shown in FIG. 10C corresponds to this information. The “validity flag” herein is updated when data is accessed actually in the recording medium, but the “information of finally validated recording region” in this modified example is updated by the controller 120, whether actually accessed to the recording region or not, when the access region is newly set by the data processing apparatus with a command (for example, region changeover command) to the recording medium.

### Embodiment 2

<System Configuration>

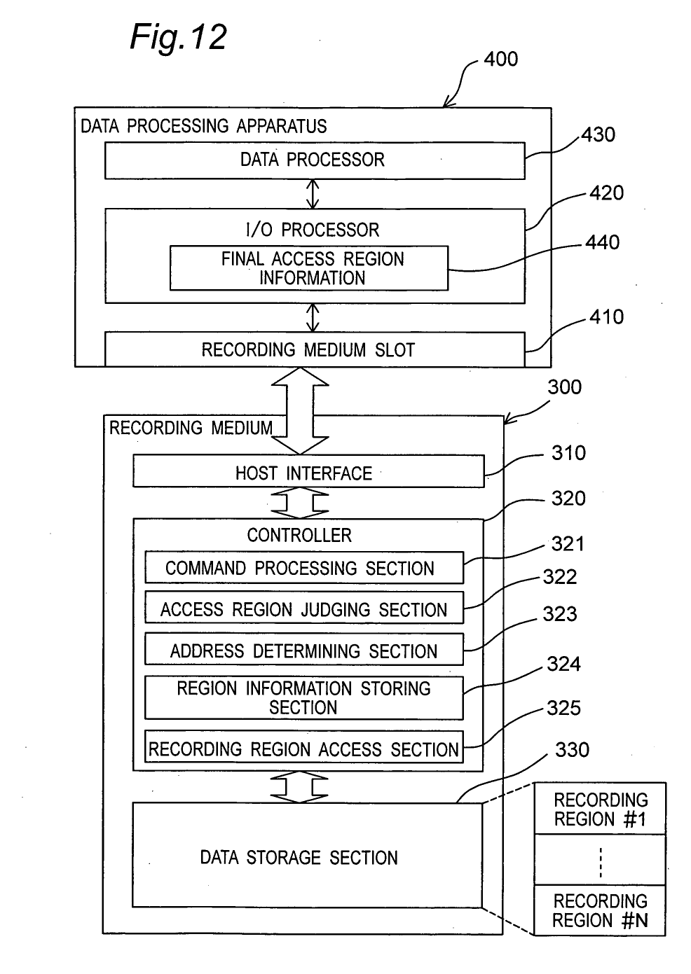

FIG. 12 is a block diagram of a recording medium 300 and a data processing apparatus 400 in embodiment 2 of the invention.

What differs from embodiment 1 is that a final access region information 440 is stored in the data processing apparatus 400 instead of the recording medium 300. That is, the constituent elements of the recording medium 300 in this embodiment basically correspond to the constituent elements of the recording medium 100 in embodiment 1, except for the portion relating to the final access region information. For example, an address determining section 323 and a recording region access section 325 in this embodiment correspond to the address determining section 123 and recording region access section 125 in embodiment 1, respectively.

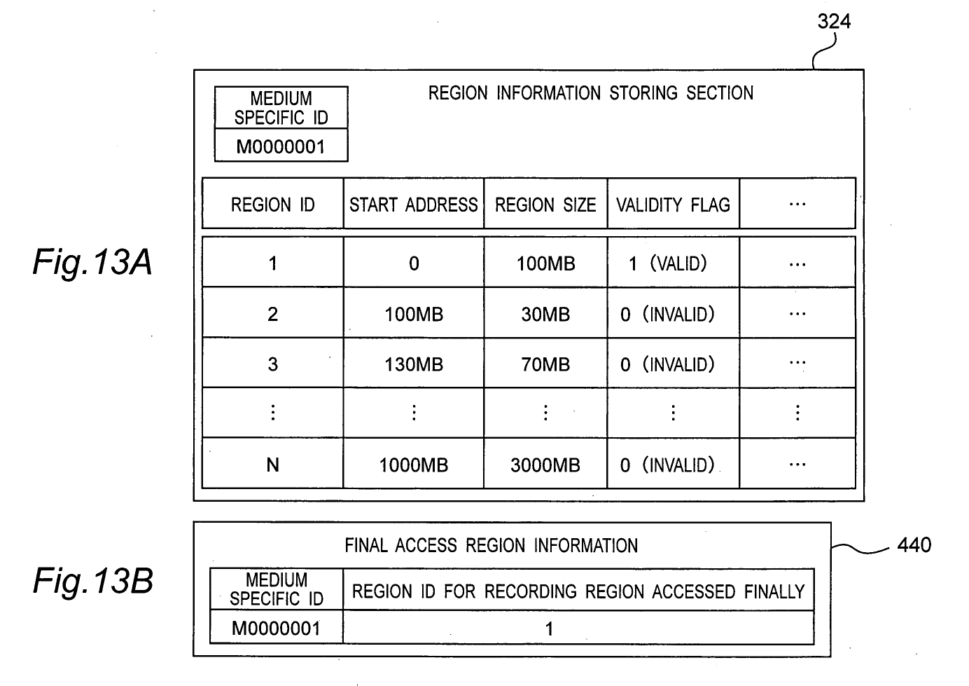

FIG. 13A shows a data structure of a region information storing section 324 in a controller 320 of the recording medium 300 in the embodiment.

The region information storing section 324 stores a region identification number for identifying each recording region, a start address showing a start point of a recording region, region size showing a size of recording region, and a validity flag showing presently valid recording region. In the region information storing section 324, a set of these information is stored corresponding to each recording region in a data storage section 330, and there are as many as the number of recording regions. What differs from embodiment 1 is that the final access flag is not included in the region information storing action 324, and that medium specific ID (identification information) is stored as an identifier which are different in every recording medium 300.

FIG. 13B shows a data structure of the final access region information 440 in this embodiment.

The final access region information 440 includes the medium specific ID and the region identification number of the finally accessed recording region.

<Initialization Process, Recording Region Changeover Process>

Initialization process of recording medium 300 in the embodiment is explained. When the recording medium 300 is connected to the data processing apparatus 400, the data processing apparatus 400 sends an initialization command to the recording medium 300 to initialize the recording medium 300. The flow of initialization process is same as in embodiment 1.

The recording region changeover process in the embodiment is explained. The recording region changeover process is executed by sending a recording region change command with the specified region identification number of the recording region desired to be validated from the data processing apparatus 400 to the recording medium 300. The flow of recording region changeover process is same as in embodiment 1.

<Reading Process of Medium Specific ID>

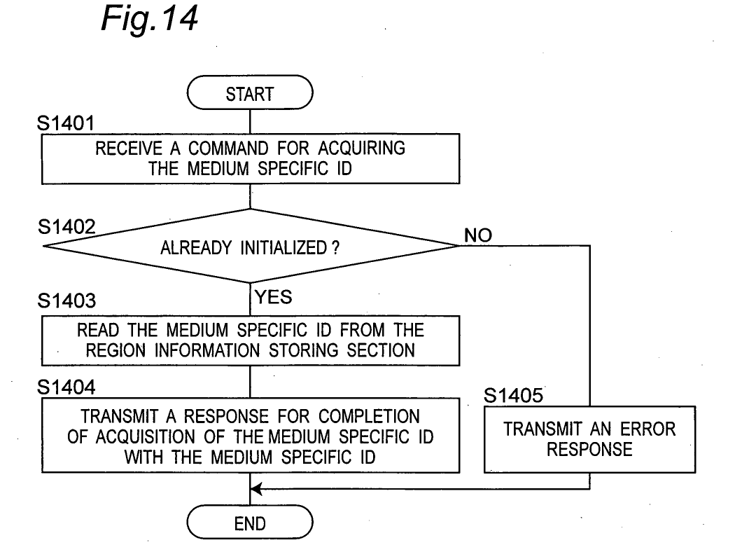

The process of reading medium specific ID from the recording medium 300 in the embodiment is as follows. The reading process of medium specific ID is executed by sending an acquisition command of medium specific ID from the data processing apparatus 400 to the recording medium 300. The reading process of medium specific ID in the recording medium 300 is specifically described by referring to the flowchart in FIG. 14.

In this process, first, a host interface 310 of the recording medium 300 receives an acquisition command of medium specific ID from the data processing apparatus 400 (S1401).

A command processing section 321 judges if the recording medium 300 has been initialized or not (S1402). If not initialized, an error response is sent to the data processing apparatus 400 by way of the host interface 310 of the recording medium 300, and the process is terminated (S1405).

If already initialized, an access region judging section 322 reads out the medium specific ID from the region information storing section 324 (S1403).

Finally, the data processing apparatus 400 is notified of the completion of reading process of the medium specific IC together with the medium specific ID being read out at S1403, by way of the host interface 310 of the recording medium 300 (S1404).

<Data Reading Process>

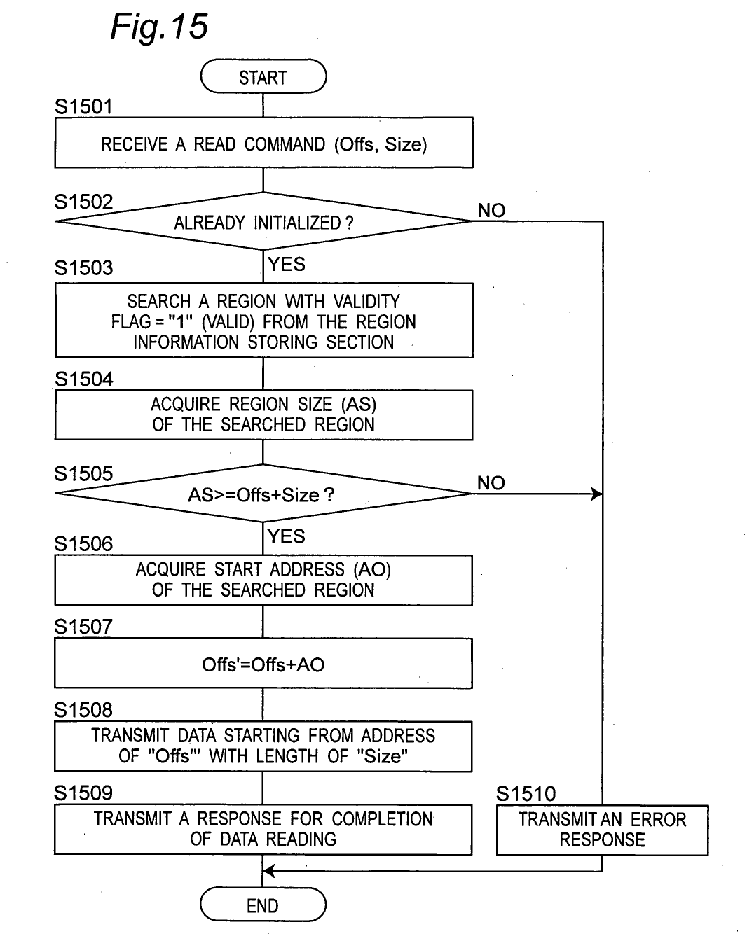

Access procedure to the recording medium 300 in the embodiment is explained by referring to an example of data reading process. Data reading or writing in the recording medium 300 is executed by sending a read or write command to the recording medium 300. FIG. 15 is a flowchart showing the data reading process in the recording medium 300. What the data reading process in this embodiment differs from the process in embodiment 1 shown in FIG. 6 is that the process about updating of final access flag (steps S609 to S611 in FIG. 6) is not present after the process at step S1508. The other process is same as in embodiment 1.

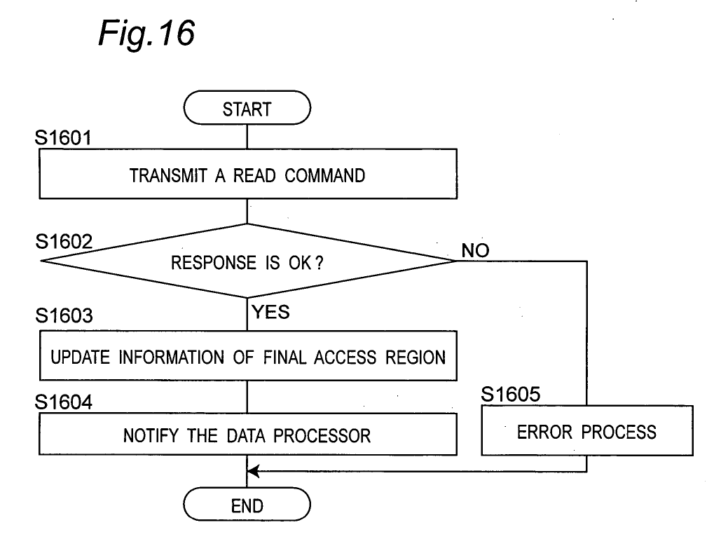

FIG. 16 is a flowchart for a data reading process of the data processing apparatus 400.

In the data reading process in the data processing apparatus 400 shown in FIG. 16, first, an I/O processor 420 of the data processing apparatus 400 sends a read command to the recording medium 300 loaded in a recording medium slot 410 (S1601). The process in the recording medium 300 when receiving the read command is same as explained in FIG. 15.

The I/O processor 420 refers to a response from the recording medium 300, and judges if the specified data is normally read or not (S1602). When the data is read incompletely, an error process is executed and the process is terminated (S1605).

When the data is read completely, the I/O processor 420 refers to the final access region information 440, and judges if the final access region information 440 matches with the region identification number of the recording region from which data is read out in the process at step S1602. Only when not matched, the value of the final access region information 440 is updated so as to be matched (S1603).

Finally, the I/O processor 420 transfers the data being read out in the process at step S1602 to a data processor 430, and the process is terminated (S1604).

<Preparation Process Before Start of Access Operation>

The explanation is made to a preparation process before start of access to the recording medium 300 which is loaded in the recording medium slot 410 by the data processing apparatus 400 in the embodiment.

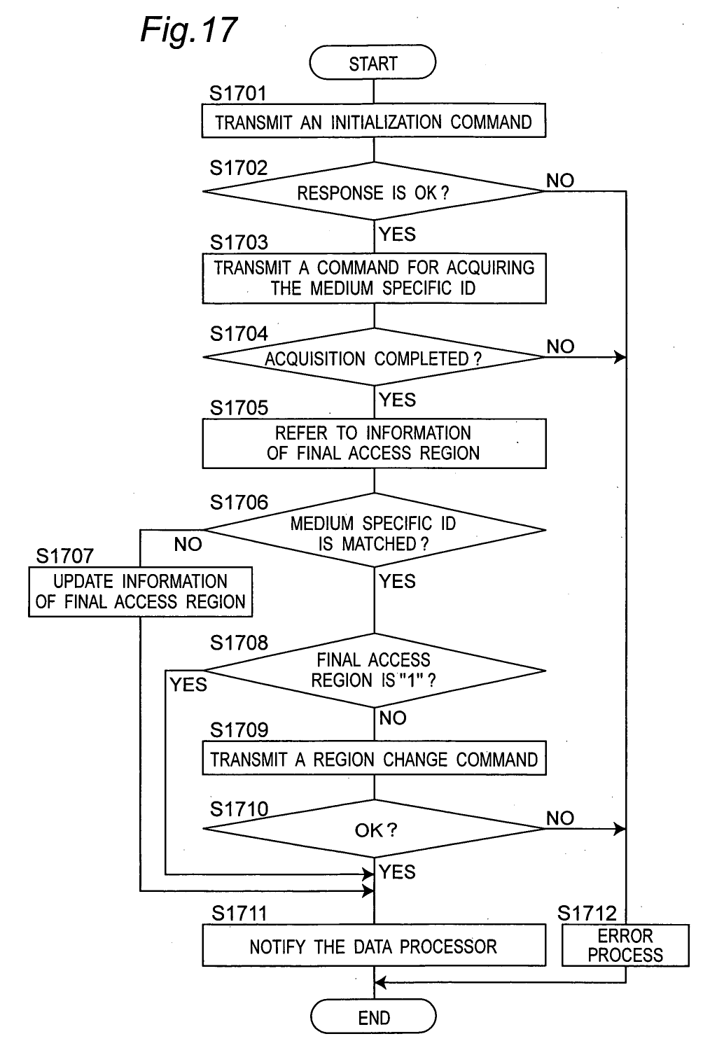

The preparation process is executed just after the recording medium 300 is loaded in the recording medium slot 410 of the data processing apparatus 400, or when turning on the power source of the data processing apparatus 400. FIG. 17 is a flowchart of preparation process.

In the preparation process, first, the I/O processor 420 of the data processing apparatus 400 sends an initialization command to the recording medium 300 loaded in the recording medium slot 410 (S1701). The process in the recording medium 300 when receiving the initialization command is same as explained in embodiment 1.

The I/O processor 420 checks if an initialization completion response to the initialization command has been received (S1702). If not received, the error process is executed and the process is terminated (S1712).

If the initialization completion response is received, the I/O processor 420 sends an acquisition command of medium specific ID to the recording medium 300 (S1703). The process in the recording medium 300 when receiving the acquisition command of medium specific ID is same as explained in FIG. 14.

The I/O processor 420 refers to a response from the recording medium 300, and checks if the medium specific ID is acquired or not (S1704). If not acquired, an error process is executed, and the process is terminated (S1712).

If acquiring the medium specific ID, the I/O processor 420 refers to the final access region information 440 (S1705), and checks if the medium specific ID acquired is matched with the medium specific ID stored in the final access region information 440 (S1706).

If the medium specific IDs are not matched, in the final access region information 440, the value of the specific medium ID is updated with the value acquired from the recording medium 300, and “1” is set at the region identification number of the finally accessed recording region (S1707), and then the I/O processor 420 notifies the data processing apparatus 430 that the preparation process for commencement of access to the recording medium 300 is completed, and the process is terminated (S1711).

When the medium specific IDs are matched, it is judged whether the region identification number of the finally accessed recording region in the final access region information 440 is “1”, that is, whether the recording region finally accessed in the last process is the first recording region which is validated currently (S1708).

If it is “1”, the I/O processor 420 sends, to the data processor 430, a notice of completion of preparation process for start of access to the recording medium 300, and the process is terminated (S1711).

If it is not “1”, the I/O processor 420 sends a recording region change command to the recording medium 300 (S1709). At this time, the argument “Num” is set by the “region identification umber of the finally accessed recording region” in the final access region information 440 referred to at step S1705. The processing in the recording medium 300 receiving the recording region change command is same as explained in embodiment 1.

The I/O processor 420 checks if a completion response of region changeover for the recording region change command has been received or not (S1710). If not received, an error process is executed, and the process is terminated (S1712).

If received, the I/O processor 420 notifies the data processor 430 that the preparation process for commencement of access to the recording medium 300 is completed, and the process is terminated (S1711).

Thus, in the recording medium, data processing apparatus, and recording region changeover method in the recording medium of the invention, the recording region can be changed over to a desired region by issuing a recording region change command before accessing the data in the recording medium 300. Therefore, when the data storage section 330 in the recording medium 300 is divided into a plurality of regions and the file system is constructed independently in each recording region, the data processing apparatus 400 can select and access a recording region managed by a file system that can be interpreted by the apparatus 400. Since the final access region information 440 is held in the data processing apparatus 400, the data processing apparatus 400 can change over a recording region to the finally accessed recording region of the last process preliminarily before start of access to the recording medium 300. Hence, user's convenience for the recording medium having a plurality of recording regions can be improved.

### MODIFIED EXAMPLES

This preferred embodiment may also have several modified examples as described below.

(1) In this embodiment, the region information storing section 324 manages four types of information as one set, that is, the region identification number, the start address, the region size, and the validity flag. However the format is not particularly specified as far as the position and size of each recording region, and the presently valid recording region can be distinguished. For example, the information of start address may be omitted by providing a limitation that each region is always consecutive.

In this embodiment, although only one set of medium specific ID and region identification number of finally accessed recording region can be stored in the final access region information 440, the final access region information 440 may be expanded to store a plurality of sets.

(2) In the embodiment, in the explanation of data reading process, the access including an access to a region exceeding a valid region is treated as an error. However, a specification which allows data which can be read to be read can be permitted.

Also in the explanation of data reading process, the reading size (Size) is set at the beginning by the data processing apparatus 400, but it may not be set preliminarily. For example, only the reading start address (Offs) may be set in advance, the recording medium 300 may sequentially read out and transmit data to the data processing apparatus 400 continuously until the data processing apparatus 400 transmits a reading stop command.

(3) In this embodiment, the data processing apparatus 400, instead of the information of the finally accessed recording region, stores information of a recording region finally read or information of a recording region finally written.

Further, instead of the information of the finally accessed recording region, the information of the number of access in each recording region may be held. In this case, the data processing apparatus 400 can automatically change over a recording region to the recording region with the greatest number of access among a plurality of recording regions included in the recording medium 300. In this case, updating the information of number of access every time accessing the recording region is heavy load for the data processing apparatus 400, and therefore, instead, the information of number of access may be counted up only when the access occurs just after changeover of the recording region. Moreover, to reduce the bit length if the information of number of access, the information of number of access may be counted up only when the number of access beyond a predetermined number. Further, to know the recording region frequently accessed recently, means for clearing the information of number of access at a specific timing may be provided. Alternatively, the information of number of access may be designed to record only the fixed number of access which occur recently.

(4) The data processing apparatus 400 may hold, instead of the information of finally accessed recording region, information about the recording region scheduled to be accessed in the first place after the next initialization process by the data processing apparatus 400.

(5) The data processing apparatus 400 may also hold, instead of the information of finally accessed recording region, the information about the recording region finally validated in the recording medium 300.

### Embodiment 3

<System Configuration>

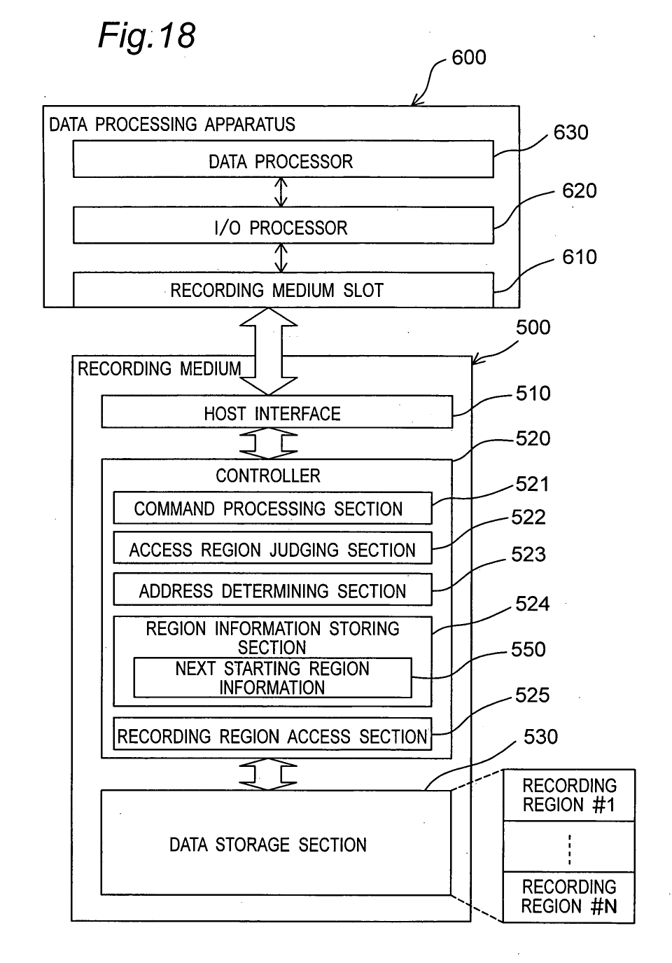

FIG. 18 is a block diagram of a recording medium 500 and a data processing apparatus 600 in embodiment 3 of the invention.

What differs from embodiment 1 is a next starting region information 550 is stored instead of the final access region information in a region information storing section 524 of the recording medium 500. The next starting region information 550 specifies a recording region to be set “valid” right after the next initialization process of the recording medium 500.

The constituent elements of the recording medium 500 in this embodiment basically correspond to those of the recording medium 100 in Embodiment 1, except for the portion relating to the next starting region information. For example, an address region judging section 522, an address determining section 523 and a recording region access section 525 in this embodiment correspond to the address region judging section 122, the address determining section 123 and the recording region access section 125 in Embodiment 1, respectively.

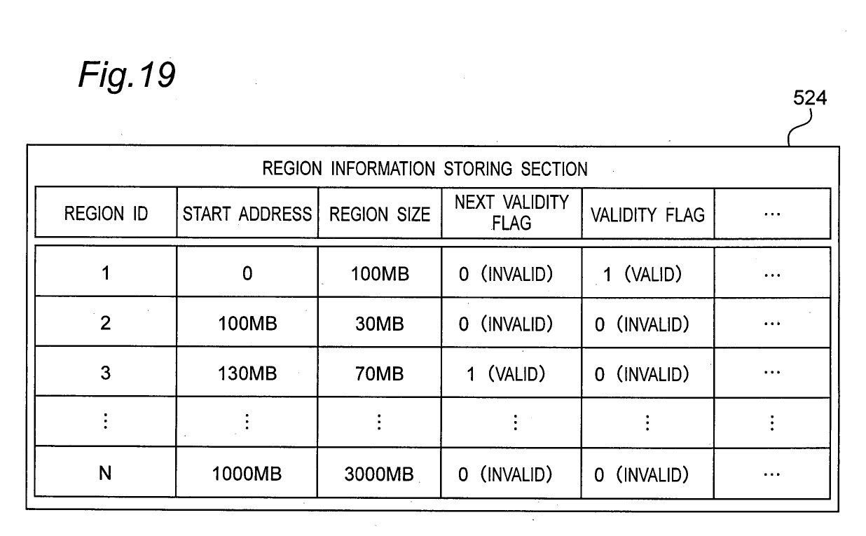

FIG. 19 illustrates data structure of the region information storing section 524 in the embodiment. The region information storing section 524 stores a region identification number for identifying each recording region of recording medium 500, a start address showing a start point of the recording region, a region size showing a length of the recording region, next validity flag showing a recording region to be set valid after next initialization process, and a validity flag showing the recording region being valid presently. Region information including these information as one set corresponds to each recording region in a data storage section 530, and there are as many as the number of recording regions. The next validity flag corresponds to the next starting region information 550.

<Initialization Process>

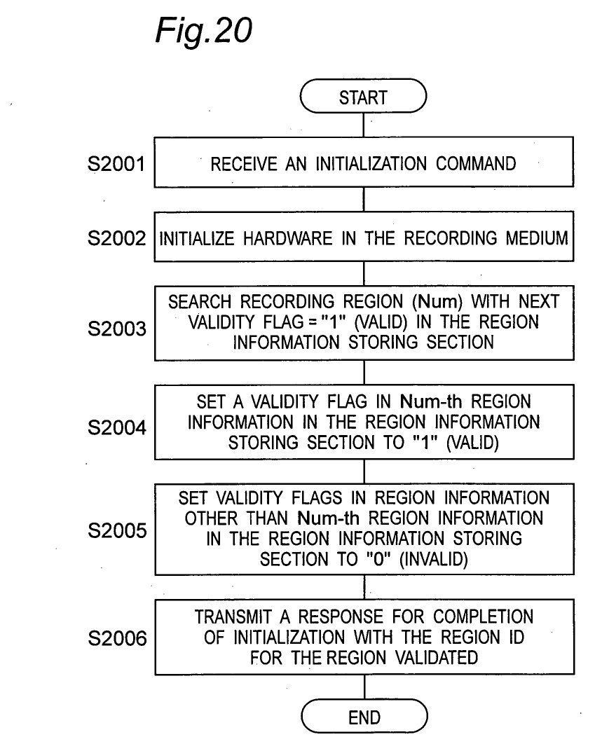

Initialization process of the recording medium 500 in this embodiment is explained. When the recording medium 500 is connected to the data processing apparatus 600, the data processing apparatus 600 sends an initialization command to the recording medium 500 to initialize the recording medium 500. FIG. 20 is a flowchart of the initialization process in the recording medium 500 of the embodiment.

In the initialization process, first, a host interface 510 of the recording medium 500 receives an initialization command from the data processing apparatus 600 (S2001).

A controller 520 and the data storage section 530 in the recording medium 500 are initialized to cause the recording medium 500 to be accessible from outside (S2002).

A region of which next validity flag is “1” (valid) is searched from a plurality of region information included in the region information storing section 524 (S2003). It is supposed that the next validity flag of Num-th region information is “1” (valid) as a result of searching.

Next, the validity flag included in the Num-th region information among a plurality of region information included in the region information storing section 524 is set to “1” (valid) (S2004).

Then, all validity flags in other region information than the Num-th region information are set to “0” (invalid) (S2005).

Finally, a response showing completion of initialization process is sent to the data processing apparatus 600 by way of the host interface 510 of the recording medium 500 together with the region identification number (Num) of the validated recording region (S2006).

At the moment of completion of the initialization process, the region information storing section 524 in the recording medium 500 has the validity flag set only in the Num-th region specified by the next validity flag, and thus only the Num-th recording region can be accessed from the data processing apparatus 600.

<Recording Region Changeover Process>

The recording region changeover process in the embodiment is explained below. The recording region changeover process is executed by sending a recording region change command with the specified region identification number of the recording region desired to be validated, from the data processing apparatus 600 to the recording medium 500. The flow of the recording region changeover process is same as in Embodiment 1.

<Data Access Procedure>

The access procedure to the recording medium 500 in this embodiment is explained. Data reading or writing from or to the recording medium 500 is executed by sending a data read command or data write command to the recording medium 500. The flow of data reading process and data writing process is same as in Embodiment 2.

<Next Validation Process>

An explanation is made to a process (“next validation process”) of specifying a recording region desired to be validated after the next initialization process in the recording medium 500 according to this embodiment.

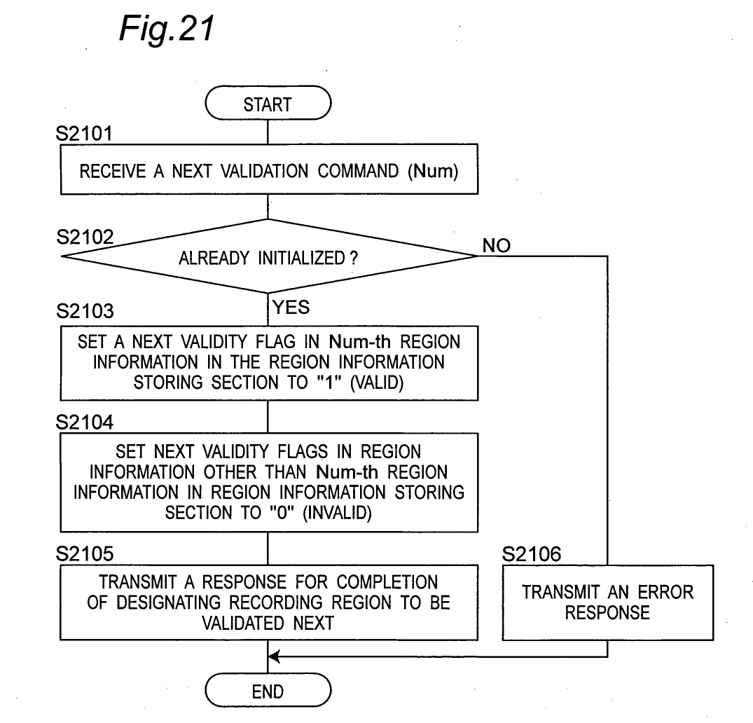

The next validation process is executed by sending a next validation command while specifying the region identification number of the recording region desired to be validated after the next initialization process, from the data processing apparatus 600 to the recording medium 500. FIG. 21 is a flowchart of the next validation process in the recording medium 500.

In the setting process of the recording region to be next validated, first, the host interface 510 of the recording medium 500 receives a next validation command from the data processing apparatus 600 (S2101). The next validation command has the following format:
Next_Int_Area (Num).

The argument “Num” specifies the region identification number to designate the region identification number of the recording region which is desired to be validated next.

A command processing section 521 judges if the recording medium 500 has been initialized (S2102). If not initialized, an error response is sent to the data processing apparatus 600 by way of the host interface 510 of the recording medium 500, and the process is terminated (S2106).

If already initialized, the command processing section 521 refers to the region identification number specified by the next validation command, and sets the next validation flag to “1” (valid) in the corresponding recording region in the region information storing section 524 (S2103).

All of next validity flags included in other region information than the recording region in which the next validity flag has been set at step S2103 are set to “0” (invalid) (S2104).

Finally, a response showing completion of setting process of the recording region to be validated next is sent to the data processing apparatus 600 by way of the host interface 510 of the recording medium 500 (S2105).

Thus, by sending a next validation command to the recording medium 500, the data processing apparatus 600 can specify the recording region which is desired to be validated automatically after the next initialization process.

<Preparation Process Before Start of Access Operation>

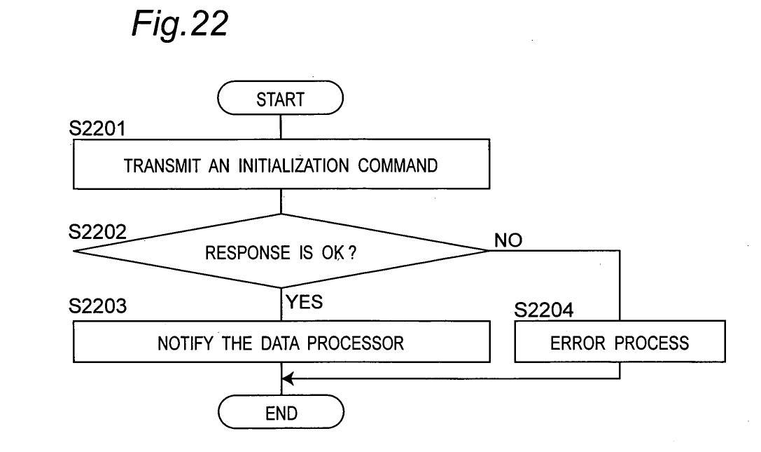

An explanation is made to the preparation process before start of access to the recording medium 500 loaded in a recording medium slot 610 by the data processing apparatus 600 according to this Embodiment. The preparation process is executed just after the recording medium 500 is loaded in the recording medium slot 610 of the data processing apparatus 600, or when the power source of the data processing apparatus 600 is turned on. FIG. 22 is a flowchart of the preparation process.

In the preparation process, first, an I/O processor 620 of the data processing apparatus 600 sends an initialization command to the recording medium 500 loaded in the recording medium slot 610 (S2201). The process of the recording medium 500 when receiving the initialization command is same as explained in FIG. 20.

The I/O processor 620 checks if an initialization completion response corresponding to the initialization command and the region identification number of the validated recording region has been received (S2202). If not received, an error process is executed, and the process is terminated (S2204).

If the initialization completion response and the region identification number of the validated recording region are received, the I/O processor 620 notifies the data processing apparatus 630 of the completion of preparation process for commencement of access to the recording medium 500, and the process is terminated (S2203).

Thus, according to the recording medium, data processing apparatus, and recording region changeover method in the recording medium of the invention, the recording region can be changed over to a desired region by issuing a recording region change command before accessing the data in the recording medium 500. Therefore, when the data storage section 530 in the recording medium 500 is divided into a plurality of regions and the file system is constructed independently in each divided recording region, the data processing apparatus 600 can select and access a recording region managed by a file system that can be interpreted by the apparatus 600. Since the next starting region information 550 is held in the recording medium 500, the recording medium 500 can change over a recording region automatically to a preliminarily specified recording region with reference to the next starting region information 550 at the initialization process. Hence, user's convenience for the recording medium having a plurality of recording regions can be improved.

### MODIFIED EXAMPLES

The invention is described by presenting the preferred embodiments, but it must be noted that the invention is not limited to the illustrated embodiments alone. The invention may be changed and modified within the scope of its true spirit. The following modified examples are also included in the scope of the invention.

(1) In this embodiment, the region information storing section 524 manages five types of information as one set, that is, the region identification number, the start address, the region size, the next validity flag, and the validity flag. However the format is not particularly specified as far as the position and size of each recording region, the presently valid recording region, and the recording region to be validated next can be distinguished. For example, the information of the start address may be omitted by providing a limitation that each region is always consecutive.

(2) The commands such as Next_Int_Area may be provided with information other than the argument cited in the embodiment as an argument. For example, a password may be used as an argument so that the apparatus capable of issuing can be limited.

(3) In the embodiment, although the next validity flag is provided as the next starting region information 550 in the region information storing section 524 and the next validity flag is referred to during the initialization process of recording medium 500, the following modified examples may also be considered.

That is, the next validity flag may be replaced by the final access flag explained in Embodiment 1. At this time, the finally accessed recording region is automatically validated after the next initialization process.

Further, instead of the information of finally accessed recording region, it may be limited to information of a recording region read finally or information of a recording region written finally.

Further, instead of the information of finally accessed recording region, it may be the information of number of access in each recording region. In this case, the recording medium 500 can automatically change over a recording region to the recording region with the greatest number of access among a plurality of recording regions in the initialization process.

Still more, updating information of number of access every time accessing the recording region is heavy load for the recording medium 500. Therefore, instead, the information of number of access may be counted up only by the access just after changeover of the recording region. Moreover, to reduce the bit length of the information of number of access, the information of number of access may be counted up only when number of access is beyond a predetermined number.

Further, to know the recording region frequently accessed recently, means for clearing the information of number of access at a specific timing may be provided. Or the information of number of access may be designed to record only the fixed number of access occurring recently.

(4) In this embodiment, the next starting region information (next validity flag) 550 set in the region information storing section 524 by the next validation process is specified to be valid until the next validation process occurs next time, but other valid term may be specified.

That is, the next starting region information 550 set in the next validation process may be valid only to the first initialization process and be cleared in the initialization process. Alternatively it may be specified to be valid up to N-th initialization process, or valid for a predetermined period.

By thus specifying the validity period, even the data processing apparatus which can not access the recording region specified by the next starting region information 550 may be capable of accessing after the validity period because the other recording region is validated in the first place when the validity period expires.

(5) In this embodiment, the next validity flag is used as the next starting region information 550. However, for a specification in which the recording region finally validated the last process is validated again after the next initialization process, the following modified example may be considered.

That is, the validity flag is stored in a nonvolatile memory or the like so that even if the recording medium 500 is extracted from the data processing apparatus 600, the finally validated recording region is held. At this time, the validity flag is also responsible for the role of the next starting region information 550.

(6) In this embodiment, the next validity flag is provided in the region information storing section 524 as the next starting region information 550, and the next validity flag is referred to in the initialization process of the recording medium 500. The following modified example may be also considered.

That is, information of the finally validated recording region may be utilized as the next starting region information 550. In this case, the finally validated recording region is automatically validated after the next initialization process.

### INDUSTRIAL APPLICABILITY

The invention can be applied to an information recording medium having a plurality of recording regions, or a data processing apparatus for accessing the medium. For example, the invention enables file management in the information recording medium with both old and new file systems, and thus it can be effectively applied in the case of providing a plurality of recording regions in the information recording medium.

The invention is described so far by referring to preferred embodiments, but other modified examples, modifications and applications are apparent for those skilled in the art. Hence the invention is not limited by the illustrated embodiments alone, but should be limited by the scope of the claims being appended. The present invention relates to Japanese Patent Application No. 2003-392218 (filed Nov. 21, 2003), of which contents are incorporated herein by reference.

1. An information recording medium to or from which data can be written or read by a data processing apparatus, comprising:
a host interface operable to communicate with the data processing apparatus;
a data storage section having a plurality of recording regions for storing data; and
a region information storing section operable to store information about each recording region in the data storage section,
wherein the region information storing section stores information about a recording region which is set first as an accessible region when the information recording medium is initialized at the next time among a plurality of recording regions in the data storage section.

2. The information recording medium according to claim 1, wherein the information about a recording region which is set first as an accessible region is information about a recording region which has been accessed finally by the data processing apparatus in a plurality of recording regions.

3. The information recording medium according to claim 1, wherein the information about a recording region which is set first as an accessible region is information about a recording region which is specified by the data processing apparatus as a region to be validated after the next initialization process.

4. The information recording medium according to claim 1, wherein the information about a recording region which is set first as an accessible region is information about number of access in each recording region.

5. The information recording medium according to claim 4, wherein the information about the number of access is counted up only at the first access time after a changeover process of the recording regions.

6. The information recording medium of claim 4, wherein the information about the number of access is counted up when a predetermined number of access occur after a changeover process of the recording regions.

7. The information recording medium of claim 4, wherein the information about the number of access is cleared when a predetermined number of initialization processes occur.

8. The information recording medium of claim 1, wherein the information about a recording region which is set first as an accessible region is information about a recording region which is set finally as an accessible region by the data processing apparatus.

9. The information recording medium of claim 1, wherein the host interface notifies the data processing apparatus of the information about a recording region which is set first as an accessible region when requested from the data processing apparatus.

10. A data processing apparatus for reading and writing data from and to the information recording medium of claim 1, comprising:
a medium slot operable to load the information recording medium;
an I/O processor operable to exchange information with the information recording medium loaded in the medium slot; and
a data processor operable to process data read from the information recording medium or data to be written to the information recording medium,
wherein the I/O processor reads the information about a recording region which is set first as an accessible region from the region information storing section of the information recording medium, and changes over the recording region in the data storage section based on the read information.

11. A data processing apparatus for reading and writing data from and to an information recording medium having specific identification information and including a plurality of recording regions, comprising:
a medium slot operable to load the information recording medium;
an I/O processor operable to exchange information with the information recording medium loaded in the medium slot, and
a data processor operable to process data read from the information recording medium or data to be written to the information recording medium,
wherein the apparatus stores identification information of the information recording medium, and information about a recording region which is set first as an accessible region when the information recording medium is initialized at the next time among a plurality of recording regions in the data storage section, and
the I/O processor changes over the recording region in the information recording medium specified by the stored identification information, based on the identification information of the recording medium and the information about a recording region which is set first as an accessible region.

12. The data processing apparatus according to claim 11, wherein the information about a recording region which is set first as an accessible region is information about a recording region which has been accessed finally by the data processing apparatus in a plurality of recording regions.

13. The data processing apparatus according to claim 11, wherein the information about a recording region which is set first as an accessible region is information about a recording region which is specified by the data processing apparatus as a region to be validated after the next initialization process.

14. The data processing apparatus according to claim 11, wherein the information about a recording region which is set first as an accessible region is information about number of access in each recording region.

15. A method of setting an accessible rerecording region in an information recording medium according to claim 1, comprising:
reading the information about a recording region which is set first as an accessible region from the region information storing section of the information recording medium; and
changing over the recording region in the data storage section based on the read information.

16. A method of setting an accessible rerecording region in an information recording medium having specific identification information and including a plurality of recording regions, comprising:
storing identification information of the information recording medium, and information about a recording region which is set first as an accessible region when the information recording medium is initialized at the next time among a plurality of recording regions in the data storage section; and
upon initialization of the information recording medium, changing over the recording region in the information recording medium specified by the stored identification information, based on the identification information of the recording medium and the information about a recording region which is set first as an accessible region.

17. The method according to claim 16, wherein information about a recording region which has been accessed finally by the data processing apparatus in a plurality of recording regions is stored as the information about a recording region which is set first as an accessible region.

18. The method according to claim 16, wherein information about a recording region which is specified by the data processing apparatus as a region to be validated after the next initialization process is stored as the information about a recording region which is set first as an accessible region.

19. The method according to claim 16, wherein information about number of access in each recording region is stored as the information about a recording region which is set first as an accessible region.

20. The method according to claim 16, wherein information about a recording region which is set finally as an accessible region by the data processing apparatus is stored as the information about a recording region which is set first as an accessible region.
